(19) United States
(12) Patent Application Publication
(10) Pub. No.: US 2022/0411154 A1
(43) Pub. Date: Dec. 29, 2022

(54) Recyclable Hemp Composition and Uses in Container Manufacturing

(71) Applicant: Robert McLoughlin, Colorado Springs, CO (US)

(72) Inventor: Robert McLoughlin, Colorado Springs, CO (US)

(21) Appl. No.: 17/843,446

(22) Filed: Jun. 17, 2022

Related U.S. Application Data
(60) Provisional application No. 63/216,215, filed on Jun. 29, 2021.

(51) Int. Cl. B65D 65/40; B32B 29/00; B32B 29/08; B65D 5/02; B32B 1/02

(52) U.S. Cl. CPC B65D 65/403; B32B 29/005; B32B 29/08; B65D 5/02; B32B 1/02; B32B 2439/62; B32B 2250/26; B32B 2262/065; B32B 2250/03

(57) ABSTRACT

The present invention relates to a cardboard container made from three layers including recyclable hemp paper. The hemp paper has a novel composition comprised of hemp infused pulp, hemp strands, and hemp fiber to add reinforced strength. The three layers include an outer liner of hemp paper, a wavy layer of the hemp paper, and an inner layer of plane hemp paper. The cardboard box is configured to replace conventional tree paper containers or boxes and can be made in various shapes and sizes. The hemp paper composition reduces the number of trees being cut down and landfill waste due to non-recyclable materials being thrown away. The container of the present invention can be recycled and provides an environmentally conscious option for users.

### CROSS-REFERENCE TO RELATED APPLICATION

The present application claims priority to, and the benefit of, U.S. Provisional Application No. 63/216,215, which was filed on Jun. 29, 2021 and is incorporated herein by reference in its entirety.

### FIELD OF THE INVENTION

The present invention relates generally to the field of cardboard boxes, containers, and papers. More specifically, the present invention relates to cardboard boxes, containers, and paper comprised of recyclable hemp composition. The box or container is constructed of hemp paper wherein the hemp paper is made of a composition including hemp infused pulp, hemp strands, and fiber to add reinforced strength. Three layers of hemp paper is used to construct the box or container for providing durability. The composition reduces the number of trees being cut down and landfill waste due to used and thrown away boxes. Accordingly, the present disclosure makes specific reference thereto. Nonetheless, it is to be appreciated that aspects of the present invention are also equally applicable to other like applications, devices, and methods of manufacture.

### BACKGROUND

By way of background, vast swatches of forests are chopped down to supply the pulp and paper industry. In fact, paper and cardboard production and consumption of same contribute to 10%-20% of deforestation and natural ecosystem degradation. It takes about 24 trees to make one ton of paper which is used for making paper products and cardboards. Further, pulp and paper mills contribute to air, water, and land pollution as nitrogen dioxide (NO2), sulfur dioxide (SO2), and carbon dioxide (CO2) are emitted during paper manufacturing. The emitted gases cause acid rain and CO2 is a major greenhouse gas that causes climate change.

Individuals discard paper and cardboards, instead of recycling, which can make up roughly 26% of solid municipal waste in landfill sites. Studies have shown that pulp and paper generate the third largest amount of industrial air, water, and land emissions in Canada and the sixth largest in the United States. From 2010 to 2060, the global consumption of pulp and paper is expected to double. An increased paper production will also add to the pressure on the world's forests that are already in a critical state—and constantly getting worse. As use of paper and cardboards is indispensable, environmental authorities, paper industry users, and consumers desire an environmentally conscious option for producing paper and cardboards.

Cardboard boxes made of conventional tree paper can sometimes be weak and fragile which can cause damage to stored items. Further, such boxes are usually thrown away by individuals after use. Individuals desire improved cardboard boxes or containers that can be recycled, and that can maintain the integrity of stored items.

Therefore, there exists a long-felt need in the art for environmentally friendly paper and cardboards. There is also a long-felt need in the art for an environmentally friendly and recyclable material that can replace conventional tree pulp and cellulose harvested from trees. Additionally, there is a long-felt need in the art for a paper and cardboard material that reduces the number of trees being cut down to manufacture paper and cardboards. Moreover, there is a long-felt need in the art for an environmentally conscious material that reduces the pollution caused by the paper manufacturing process. Further, there is a long-felt need in the art for environmentally friendly paper and cardboards that are recyclable and cost-effective. Furthermore, there is a long-felt need in the art for cardboard boxes or containers that are compact, lightweight, durable, and maintain integrity of stored items. Finally, there is a long-felt need in the art for an improved cardboard material that can be used for constructing durable boxes and containers while being environmentally conscious and cost-effective.

The subject matter disclosed and claimed herein, in one embodiment thereof, comprises a recyclable and environmentally conscious cardboard box or container material composition. As described herein, ‘cardboard’ or ‘corrugated cardboard’ is used as a generic term to denote a heavy paper based constructed material. The composition of corrugated cardboard typically consists of a paper pulp material. Pulp is predominately made from timber, however it can also be created using recycled woodchips and shavings leftover from lumber mill waste. To be described in more detail hereinafter, the cardboard material composition of the present invention comprises a hemp infused pulp material present in an amount of from about 30% to 60%; a hemp strands material present in an amount of from about 10% to 30% and a short hemp fiber material present in an amount of from about 20% to 40%, wherein the hemp infused pulp material is formed by processing residuals from hemp agricultural crops. The composition reduces the number of timber trees being cut down and allows users to create several different shapes and sizes of boxes to accommodate all user needs and preferences.

In this manner, the novel cardboard material of the present invention accomplishes all of the foregoing objectives and provides users with a novel composition that is environmentally conscious and that can be used in manufacturing cardboard boxes and containers. The cardboard boxes/containers made from the composition can be of any shape and size and are compact, lightweight, durable, and are able to maintain the integrity of stored items. The composition helps in reducing deforestation, timber preservation, and paper waste production.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cardboard material composition. The cardboard material composition further comprises a hemp infused pulp material present in an amount of from about 30% to 60%; a hemp strands material present in an amount of from about 10% to 30% and a short hemp fiber material present in an amount of from about 20% to 40%, wherein the hemp infused pulp material is formed by processing residuals from hemp agricultural crops.

In yet another embodiment, a hemp cardboard box is disclosed. The hemp cardboard box further comprises an outer layer of hemp paper liner, a middle wavy layer of hemp paper, and an inner layer of thick hemp paper wherein the hemp paper has a composition of 30% to 60% hemp infused pulp material, 10% to 30% hemp strands material, and 20% to 40% short hemp fiber material.

In yet another embodiment, the hemp paper has a grammage between 320 g/m² and 520 g/m².

The hemp composition material for cardboard boxes and containers of the present invention is a sustainable alternative to conventional paper made from wood. Further, the box/container and the hemp paper are resource-saving, high-quality, durable, and recyclable.

In yet another embodiment, a recyclable cardboard box or container is disclosed. The cardboard container includes an outer layer made of hemp paper liner, a wavy middle layer of the hemp paper, and an inner layer of plane hemp paper wherein the hemp paper is made from hemp infused pulp, hemp strands, and hemp fiber.

In yet another embodiment, a method of forming a recyclable hemp material composition is described. The method includes the steps of initially cutting hemp bast using a hemp cutter; creating, by a pulping machine, a pulp from the hemp; processing and coloring or bleaching as desired on the pulp; adding hemp strands and hemp fibers to the pulp; and drying the composition and forming the hemp paper. Bast refers to the phloem, or tissue that grows along the stems or trunks of plants. Bast can be extracted from the inner barks of some trees, vines, and plants, such as hemp, nettle, and flax. The fibers are traditionally separated from the other plant material through a process called retting

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a hemp cardboard container of the present invention in accordance with the disclosed architecture;

FIG. 2 illustrates one potential embodiment of the hemp material composition used for making the hemp paper used in manufacturing of the hemp cardboard containers of the present invention in accordance with the disclosed architecture;

FIG. 3 illustrates a flow chart showing exemplary steps in manufacturing of hemp material cardboard containers of the present invention in accordance with the disclosed architecture; and

FIG. 4 illustrates a cross-sectional view of an exemplary hemp material cardboard of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for environmentally friendly paper and cardboards. There is also a long-felt need in the art for an environmentally friendly and recyclable material that can replace conventional tree pulp and cellulose harvested from trees. Additionally, there is a long-felt need in the art for a paper and cardboard material that reduces the number of trees being cut down to manufacture paper and cardboards. Moreover, there is a long-felt need in the art for an environmentally conscious material that reduces the pollution caused by the paper manufacturing process. Further, there is a long-felt need in the art for environmentally friendly paper and cardboards that are recyclable and cost-effective. Furthermore, there is a long-felt need in the art for cardboard boxes or containers that are compact, lightweight, durable, and maintain the integrity of stored items. Finally, there is a long-felt need in the art for an improved cardboard material that can be used for constructing durable containers while being environmentally conscious and cost-effective.

The present invention, in one exemplary embodiment, is a novel material hemp cardboard container. The hemp cardboard container further comprises an outer layer of hemp paper liner, a middle wavy layer of hemp paper, and an inner layer of thick hemp paper wherein the hemp paper has a composition of 30% to 60% hemp infused pulp material, 10% to 30% hemp strands material, and 20% to 40% short hemp fiber material.

As used herein, the term “pulp” refers to fibrous material obtained through conventional bast processes of hemp plant known in the arts. This can be for long bast fiber or short bast fiber.

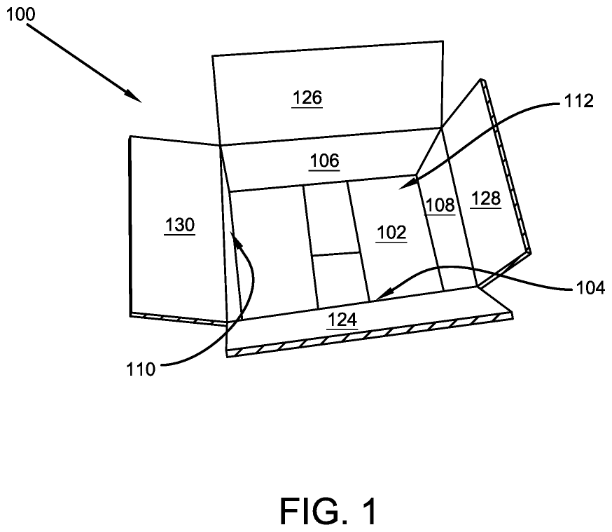

Referring initially to the drawings, FIG. 1 illustrates a perspective view of one potential embodiment of the hemp cardboard container of the present invention in accordance with the disclosed architecture. The hemp cardboard container 100 of the present invention is constructed using hemp paper rather than standard tree paper. The container 100 enables users to carry items without destroying the integrity of the items stored therein. More specifically, the box or container 100 has a bottom wall 102 and four vertical walls 104, 106, 108, 110 extending vertically from the edges of the bottom wall 102 to define a cavity 112 for storing items therein.

The walls 102, 104, 106, 108, 110 are multilayered with hemp paper forming a plurality of layers in each wall. The walls 104, 106, 108, 110 include lid portions 124, 126, 128, 130, respectively. The lid portions 124, 126, 128, 130 are formed to cover the cavity 112 when at least two of the lid portions 124, 126, 128, 130 are closed over the cavity 112. When the lid portions 124, 126, 128, 130 are in full communication with the top edges of walls 104, 106, 108, 110, an enclosed, watertight, or water resistant, space is defined. One or more layers of the hemp paper can be wavy for providing a corrugated cardboard box or container 100. It is to be appreciated that although the container 100 is shown as a box in FIG. 1, any geometric configuration can be utilized for the container.

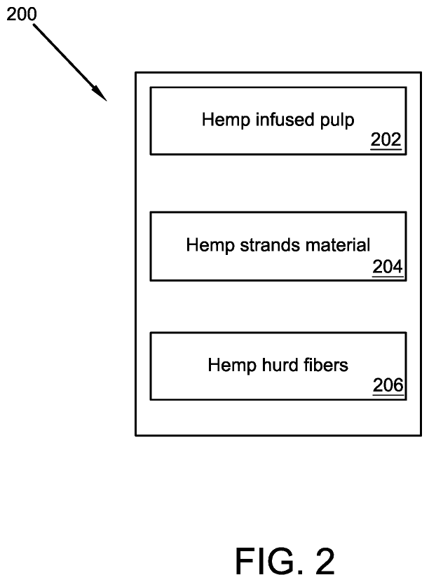

FIG. 2 illustrates one potential embodiment of the hemp material composition used for making the hemp paper used in manufacturing of the hemp cardboard box/container of the present invention in accordance with the disclosed architecture. The hemp material composition 200 is uniquely designed to provide reinforced strength which increases the tensile strength of the paper. More specifically, the composition 200 has hemp infused pulp 202 wherein the pulp 202 contains from about 75% to about 95% cellulose content. The pulp 202 is preferably made from short bast fiber but can also be made from long bast fiber. The pulp 202 does not contain lignin content and is produced in a paper pulper machine from hemp material. The amount of hemp infused pulp 202 in the composition 200 can be present from about 10% to about 60%, by weight of the composition. In another embodiment, the amount of hemp infused pulp 202 in the composition can be present from about 20% to about 50%, by weight of the composition. In yet another embodiment, the amount of hemp infused pulp 202 in the composition can be present from about 30% to about 40%, by weight of the composition.

The hemp pulp paper is not strong and is soft. Therefore, for making cardboard containers, the pulp 202 is combined with hemp strands material 204 to strengthen the quality of paper produced from the composition 200. Hemp strands material 204 are used as natural lignocellulosic fibers to add strength to the pulp. The hemp strands material 204 is treated with surface chemical treatment to reduce hydrophilic nature thereof and thus helping in long life of resulting paper and cardboard containers. The amount of hemp strands material 204 in the composition 200 can be present from about 5% to about 30%, by weight of the composition. In another embodiment, the amount of hemp strands material 204 in the composition 200 can be present from about 10% to about 25%, by weight of the composition.

The composition 200 also includes hemp hurd fibers 206 that are strong, flexible, and have a relatively low-density. Hemp fibers 206 also provide great tensile strength to the resulting paper which the cardboard containers are made. The amount of hemp hurd fibers 206 in the composition 200 can be present from about 10% to about 45%, by weight of the composition. In another embodiment, the amount of hemp hurd fibers 206 in the composition 200 can be present from about 20% to about 30%, by weight of the composition. Industrial hemp stalks contain two key types of fibers: bast and hurd. Bast fibers are long and string-like and found on the outer portions of hemp stalks. Conversely, hurd fibers resemble wood chips in their structure and are found in the interior of hemp stalks.

It should be noted that the hemp paper made from the composition is natural, recyclable, does not induce an allergic reaction, and demonstrates desirable flexibility and strength for making a variety of cardboard containers. The hemp cardboard material composition 200 of the present invention is environmentally friendly and cost-effective without sacrificing the quality of containers. One field of hemp yields four to five times as much paper as a forest of the same size and therefore, reduces deforestation. Hemp can be harvested three times each year, but conventional trees can be harvested only once every seven years. Hemp does not deplete the soil, so a hemp field can be replanted immediately after the harvest. Further, Hemp plants are naturally pest-resistant, so their cultivation requires fewer pesticides. Hemp eliminates weeds on its own, so fewer herbicides are applied. The fibers in pulp made from hemp are five times longer than the fibers in pulp made from wood and have greater tensile, tear, and wet strength compared to wood fibers.

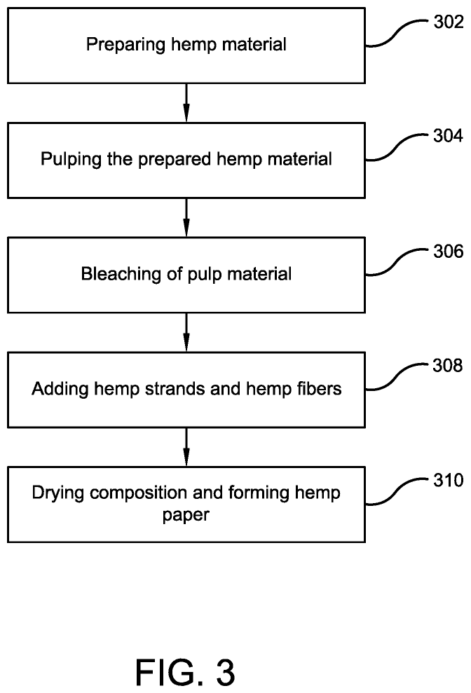

FIG. 3 illustrates a flow chart showing exemplary steps in manufacturing of hemp material cardboard containers of the present invention in accordance with the disclosed architecture. Initially, a hemp cutter machine is used for preparing the hemp material used for manufacturing the composition (Step 302). Then, the hemp material is dumped into a pulping machine that may deploy a pulping process, such as chemical pulping process for creating hemp pulp material (Step 304). The pulping process includes delignification of hemp fibers and treatment with sodium hydroxide, and sodium sulfide across several steps. The pulp can be further processed to remove additional impurities through washing, screening, and can be subjected to additional defibering or de-knotting.

Then, the coloring or bleaching process of the resultant pulp is processed to increase yield of the pulp (Step 306). Thereafter, hemp strands and hemp fibers are added to the pulp for reinforcing strength of the composition (Step 308). The composition is dried and reinforced hemp paper is formed using paper making machines (Step 310).

In the next step, multiple layers of the hemp paper, including a liner layer and a wavy layer (i.e. fluting paper), are fed through a corrugated roller, including steam and glue, for preparing the cardboard containers (Step 312). Liners can be glued to corrugated board and then cut to size. The size, design, and configuration of the cardboard containers can be configured as per the requirements of users and the containers can also be made with less fluting (corrugation). Corrugator separates boards into layers and stacks them to be fed into a trimmer and scored. A bending machine folds the boxes on the scored lines and glue is applied as needed. Off-cuts are used to produce more boxes if desired.

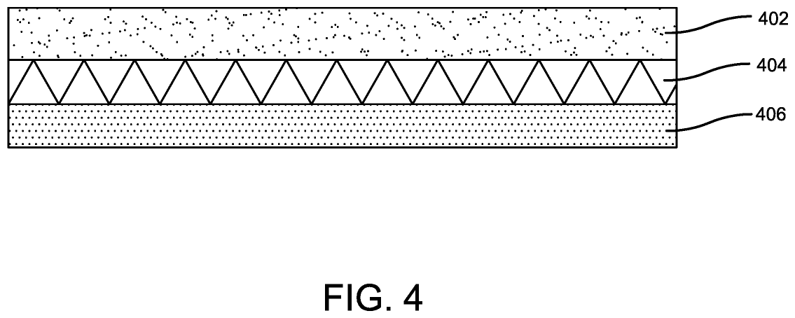

FIG. 4 illustrates a cross-sectional view of an exemplary hemp material cardboard box of the present invention in accordance with the disclosed architecture. The cardboard box 100 uses a plurality of layers of hemp paper for providing adequate strength. The outer layer or liner 402 is made of a liner of hemp paper for providing reinforced strength. The outer layer or liner 402 also helps in keeping the stored products, safe, hygienic, and clean. The outer layer 402 can have a thickness of about 0.5 cm-1 cm.

A middle layer 404 is made of wavy or crimped hemp paper for providing a corrugated look and feel to the cardboard box. The middle layer 404 is slightly thicker than the outer layer 402 and has a thickness of about 1 cm-2 cm. The inner layer or liner 406 is made of plane hemp paper and provides the necessary smoothness and stability to the cardboard box.

It should be noted that the plurality of layers and/or liners of the cardboard containers of the present invention have a composition described in FIG. 2. Further, the layers are attached to each other using an adhesive that permanently attaches the layer to each other forming a durable cardboard. The cardboard containers can function similar to conventional boxes and can be designed in various sizes and shapes.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cardboard box”, “hemp cardboard box”, and “recyclable cardboard box” are interchangeable and refer to the hemp cardboard box 100 of the present invention. Similarly, as used herein “hemp material composition”, “hemp composition”, and “cardboard material composition” are interchangeable and refer to the cardboard hemp composition 200 of the present invention.

Notwithstanding the foregoing, the hemp cardboard box 100 of the present invention can be of any suitable size and configuration as is known in the art without affecting the overall concept of the invention, provided that it accomplishes the above stated objectives. One of ordinary skill in the art will appreciate that the hemp cardboard box 100 as shown in the FIGS. are for illustrative purposes only, and that many other sizes and shapes of the hemp cardboard box 100 are well within the scope of the present disclosure. Although the dimensions of the hemp cardboard box 100 important design parameters for user convenience, the hemp cardboard box 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hemp based cardboard container comprising:
a bottom wall;
a set of four sidewalls extending generally vertically from a respective edge of said bottom wall;
wherein at least two of said set of four sidewalls each include a lid portion;
wherein said bottom wall, said set of four sidewalls, and the two lid portions define a cavity for storing an item therein;
wherein said bottom wall, said set of four sidewalls, and the two lid portions are comprised of a plurality of hemp infused pulp paper layers;
wherein each of said plurality of hemp infused pulp paper layers comprises a composition from about 75% to about 95% of a cellulose;
wherein said composition is comprised of a short bast fiber or a long bast fiber; and
further wherein the composition comprises a hemp infused pulp that is about 10% to about 60% by weight of the composition.

2. The hemp based cardboard container of claim 1, wherein said plurality of hemp infused pulp paper layers comprise three layers.

3. The hemp based cardboard container of claim 2, wherein at least one of said three layers is a wavy layer.

4. The hemp based cardboard container of claim 2, wherein at least one of said three layers is a corrugated layer.

5. The hemp based cardboard container of claim 1, wherein the hemp infused pulp is from about 20% to about 50% by weight of the composition.

6. The hemp based cardboard container of claim 1, wherein the hemp infused pulp is from about 30% to about 40%, by weight of the composition.

7. A hemp based cardboard container comprising:
a container having a plurality of walls defining a cavity for storing an item therein;
wherein each of said plurality of walls are comprised of three layers of a hemp infused pulp paper;
wherein at least one of said three layers is a corrugated layer;
wherein said hemp infused pulp paper comprises a composition of about 75% to about 95% of a cellulose, by weight;
wherein said composition comprises about 10% to about 60% of a hemp infused pulp, by weight;
wherein said composition comprises about 5% to about 30% of a plurality of hemp strands, by weight; and
further wherein said composition comprises about 10% to about 45% of a plurality of hemp hurd fibers, by weight.

8. The hemp based cardboard container of claim 7, wherein the hemp infused pulp comprises about 20% to about 50% by weight of the composition.

9. The hemp based cardboard container of claim 7, wherein the hemp infused pulp comprises about 30% to about 40% by weight of the composition.

10. The hemp based cardboard container of claim 7, wherein the plurality of hemp strands comprise about 10% to about 25% by weight of the composition.

11. The hemp based cardboard container of claim 7, wherein the plurality of hemp hurd fibers comprise about 20% to about 30% by weight of the composition.

12. The hemp based cardboard container of claim 7, wherein the composition comprises a short bast fiber or a long bast fiber.

13. The hemp based cardboard container of claim 7, wherein the corrugated layer is a middle layer.

14. The hemp based cardboard container of claim 13, wherein the hemp infused pulp comprises about 20% to about 50% by weight of the composition.

15. The hemp based cardboard container of claim 13, wherein the hemp infused pulp comprises about 30% to about 30% by weight of the composition.

16. A hemp based cardboard container comprising:
a container having a plurality of walls defining a cavity for storing an item therein;
wherein said plurality of walls are comprised of a plurality of hemp infused pulp paper layers;
wherein said plurality of hemp infused pulp paper layers comprises an outer layer, a middle layer and an inner layer;
wherein said middle layer is a corrugated layer;
wherein said hemp infused pulp paper layers comprises a composition comprising about 75% to about 95% of a cellulose, by weight;
wherein said composition further comprises a hemp infused pulp that is about 20% to about 50% by weight of the composition;
wherein said composition further comprises a plurality of hemp strands that are about 10% to about 25% by weight of the composition; and
further wherein said composition further comprises a plurality of hemp hurd fibers that are about 20% to about 45% by weight of the composition.

17. The hemp based cardboard container of claim 16, wherein the hemp infused pulp is about 30% to about 40% by weight of the composition.

18. The hemp based cardboard container of claim 16, wherein said outer layer comprises a thickness from about 0.5 cm to about 1.0 cm.

19. The hemp based cardboard container of claim 18, wherein said middle layer comprises a thickness from about 1.0 cm to about 2.0 cm.

20. The hemp based cardboard container of claim 19, wherein said hemp infused pulp paper composition is comprised of a plurality of short bast fibers or a plurality of long bast fibers.
